(19) United States
(12) Patent Application Publication
(10) Pub. No.: US 2016/0349984 A1
(43) Pub. Date: Dec. 1, 2016

(54) Method and System for Unlocking a Touch Screen of a Mobile Electronic Device

(71) Applicants: Weimin Ding, San Jose, CA (US); Boogoo Intellectual Property LLC, Westlake Village, CA (US)

(72) Inventor: Weimin Ding, San Jose, CA (US)

(73) Assignees: Boogoo Intellectual Property LLC, Westlake Village, CA (US); Weimin Ding, San Jose, CA (US)

(21) Appl. No.: 15/154,772

(22) Filed: May 13, 2016

Related U.S. Application Data
(60) Provisional application No. 62/166,073, filed on May 25, 2015.

(51) Int. Cl. G06F 3/0488; G06F 3/0484; G06F 3/0482

(52) U.S. Cl. CPC G06F 3/04883; G06F 3/0482; G06F 3/0484

(57) ABSTRACT

This invention discloses a method and system that provides a user multiple options to unlock a touch screen of a mobile electronic device (e.g., a smartphone, tablet computer) by interacting with one or more unlock images displayed on the touch screen. When the user chooses one of the multiple options to unlock the touch screen, the invention unlocks the screen and causes an application corresponding to the option to perform an action. The application is selected from a plurality of applications installed on the mobile electronic device based on its location.

### CROSS-REFERENCE TO RELATED APPLICATIONS

This application claims priority to U.S. provisional patent application Ser. No. 62/166,073, filed May 25, 2015, the entire contents of which are incorporated herein by reference.

### FIELD OF INVENTION

This invention generally relates to user interaction with a mobile electronic device. More specifically, this invention relates to unlocking a touch screen of a mobile electronic device.

### BACKGROUND OF THE INVENTION

More and more mobile electronic devices (hereinafter “mobile device” or “mobile devices”), such as smartphones, are using touch screens as their input and display components. Various applications (or software programs) can operate on these mobile devices. In addition, these mobile devices may be configured to automatically enter a sleep mode, under which the touch screen is deactivated, to save power and to prevent accidental activation of certain device features (e.g., calling, messaging). A user can wake up a mobile device from a sleep mode by, for example, pushing a home button. The touch screen of the mobile device, however, can be locked to provide security protection. Under locked mode, a user still cannot access the features of a mobile device unless the user unlocks the screen and the mobile device. In recent designs, a user is required to swipe a touch screen in a certain pattern with a finger to unlock a screen or device (or to get to the screen where the user can type in a passcode). Other finger gestures have been proposed in lieu of swiping or dragging. For example, U.S. patent application Ser. No. 13/733,639 proposes a sequence of one or more press gestures on a touch screen as a way to unlock the screen. In U.S. Pat. No. 8,046,721, the named inventors proposed a design that provided multiple “unlock images,” each corresponding to an active application running or an event received while the device was locked. Performing the unlock action by dragging or moving one of the multiple unlock images in a predefined manner would unlock the screen and device and display the application and/or event corresponding to the unlock image. However, with any particular unlock image, there was only one dragging or moving option. Also, there was only one unlock image for each application or event. After the touch screen was unlocked and the corresponding application or event was displayed on the screen, the user still needed to look for the particular function or feature he/she wanted to use, which required the user to engage additional interactions with the touch screen.

Therefore, there is a need for a method and system that provides a user multiple options to interact with an unlock image on a locked touch screen, and each option, requiring only a single action from the user, would unlock the screen and cause an application or event corresponding to the unlock image to enter a different state (e.g., being displayed on the screen with a different function/feature invoked/activated) or perform a different action (e.g., processing data, transmitting a message, or establishing a network connection).

### SUMMARY OF THE INVENTION

In one embodiment of the present invention, a method and system for unlocking a touch screen of a mobile device is disclosed. When a user wakes up his/her mobile device from a sleep mode, the touch screen of the device displays an unlock image (i.e., a graphical, interactive user-interface object with which the user interacts in order to unlock the device), which represents an application/event, and provides multiple options for the user to interact with the unlock image, each option unlocking the touch screen and causing the application/event to enter a different state or perform a different action.

In another embodiment of the present invention, when a user wakes up his/her mobile device from a sleep mode, the touch screen of the device displays multiple unlock images to represent a single application/event. The user can interact with each unlock image to unlock the screen and cause the application/event to enter a different state or perform a different action.

In yet another embodiment of the present invention, after a user wakes up his/her mobile device from a sleep mode, the touch screen of the device displays multiple unlock images, each representing an application/event, and provides multiple options for the user to interact with each unlock image, each option unlocking the touch screen and causing the corresponding application/event to enter a different state or perform a different action. The unlock images can be displayed one at a time on the screen or certain unlock images can be grouped together for display on the screen.

In yet another embodiment of the present invention, a mobile device automatically selects a particular application/event and wakes up itself based on the current time or its current location. An unlock image representing the application/event is displayed. For example, upon determining that a user is near his/her car, a car application may be selected and the unlock image representing the car application is displayed on a locked touch screen of the user's mobile device. Also, as described above, the system provides multiple options for the user to interact with the unlock image on the screen to unlock the screen and trigger different functions or features of the car application (e.g., navigation, entertainment, door lock control, or interior control).

### BRIEF DESCRIPTION OF THE DRAWINGS

FIG. 1 is a block diagram illustrating a mobile device, according to some embodiments of the present invention.

FIG. 2 illustrates an unlock image displayed on a locked touch screen of a mobile device, according to some embodiments of the present invention.

FIG. 3 illustrates a plurality of unlock images displayed on a locked touch screen of a mobile device, according to some embodiments of the present invention.

FIG. 4 illustrates an unlock image displayed on a locked touch screen of a mobile device, according to some embodiments of the present invention.

FIG. 5 illustrates a plurality of unlock images displayed on a locked touch screen of a mobile device, according to some embodiments of the present invention.

FIG. 6 illustrates a plurality of unlock images displayed on a locked touch screen of a mobile device, according to some embodiments of the present invention.

FIG. 7 is a flow diagram illustrating a process of unlocking a locked touch screen of a mobile device, according to some embodiments of the present invention.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

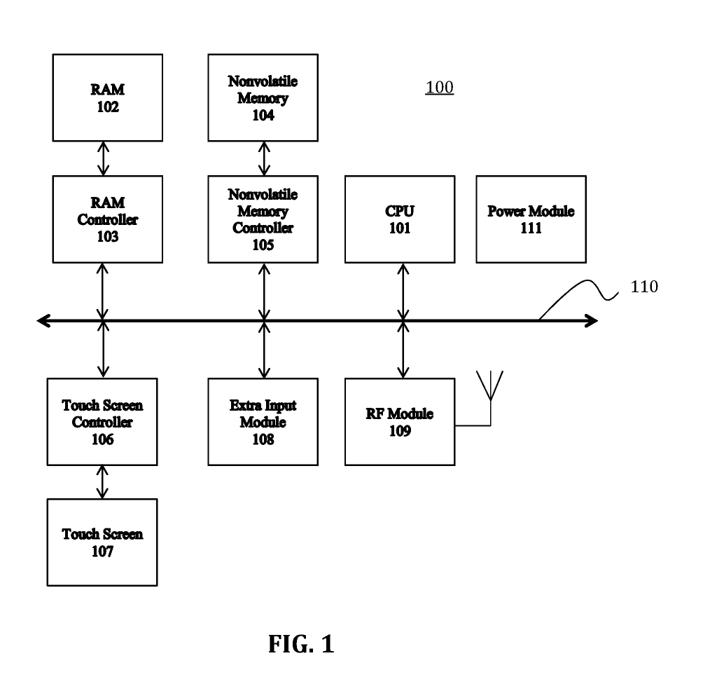

FIG. 1 is a block diagram illustrating a mobile device, according to an embodiment of the present invention. The mobile device 100 includes a central processing unit (CPU) 101, a random access memory (RAM) 102, a RAM controller 103, a nonvolatile memory 104, a nonvolatile memory controller 105, a touch screen controller 106, a touch screen 107, an extra input module 108, an RF module 109. These components communicate over the one or more communication buses or signal lines 110. The mobile device 100 can be any portable electronic device, including but not limited to a handheld computer, a tablet computer, a mobile phone, a media player, a personal digital assistant (PDA), or the like, including a combination of two or more of these items. It should be appreciated that the mobile device 100 is only one example of a mobile electronic device, and that the mobile device 100 may have more or fewer components than shown, or a different configuration of components. The various components shown in FIG. 1 may be implemented in hardware, software or a combination of both hardware and software, including one or more signal processing and/or application specific integrated circuits.

The RAM 102 may include one or more static RAM (SRAM) or dynamic RAM (DRAM) modules. Access to the RAM 102 by other components of the mobile device 100, such as the CPU 101, may be controlled by the RAM controller 103. The nonvolatile memory 104 may include one or more magnetic disk storage devices, flash memory devices, or other non-volatile solid state memory devices. Access to the nonvolatile memory 104 may be controlled by the nonvolatile memory controller 105. The CPU 101 runs various software programs and/or sets of instructions stored in the RAM 102 to perform various functions for the mobile device 100 and to process data.

The RF (radio frequency) module 109 receives and sends electromagnetic waves. The RF module 109 converts electrical signals to/from electromagnetic waves and communicates with communications networks and other communications devices via the electromagnetic waves. The RF module 109 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF module 109 may communicate with the networks, such as the Internet, also referred to as the World Wide Web (WWW), an Intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols not yet developed as of the filing date of this document.

The touch screen 107 provides both an output interface and an input interface between the mobile device and a user. The touch screen controller 106 receives/sends electrical signals from/to the touch screen 107. The touch screen 107 displays visual output to the user. The visual output may include text, graphics, video, and any combination thereof.

The touch screen 107 also accepts input from the user based on haptic and/or tactile contact. The touch screen 107 forms a touch-sensitive surface that accepts user input. The touch screen 107 and the touch screen controller 106 (along with any associated modules and/or sets of instructions in the RAM 102) detects contact (and any movement or break of the contact) on the touch screen 107 and converts the detected contact into interaction with user-interface objects, such as one or more soft keys, that are displayed on the touch screen. In an exemplary embodiment, a point of contact between the touch screen 107 and the user corresponds to one or more digits of the user. The touch screen 107 may use LCD (liquid crystal display) technology, or LPD (light emitting polymer display) technology, although other display technologies may be used in other embodiments. The touch screen 107 and touch screen controller 106 may detect contact and any movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 107.

The extra input module 108 may include physical buttons (e.g., push buttons, rocker buttons, etc.), dials, slider switches, sticks, and so forth.

The mobile device 100 also includes a power module 111 for powering the various components. The power module 111 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

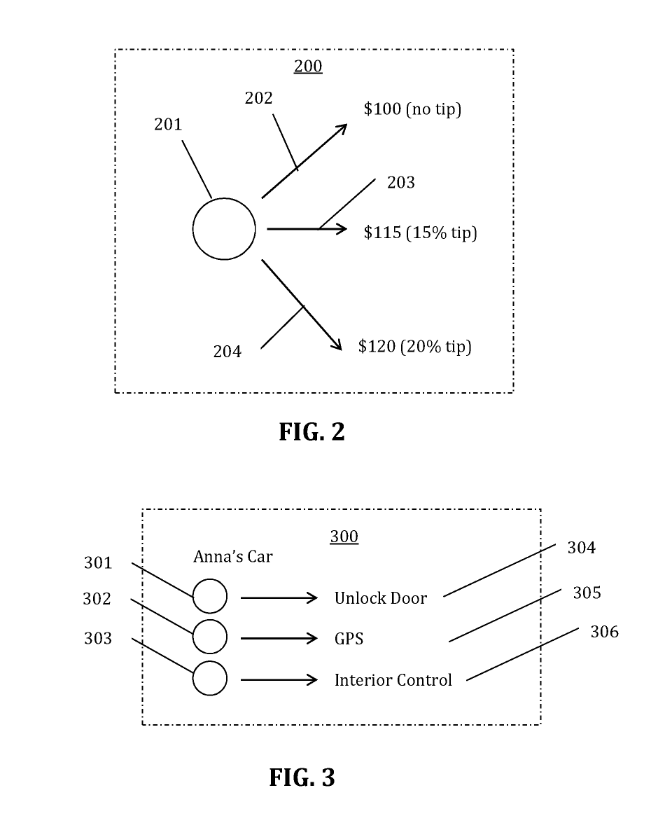

FIG. 2 illustrates an unlock image displayed on a locked touch screen of a mobile device, according to some embodiments of the present invention. As shown in FIG. 2, a graphical user interface 200 is displayed on a locked touchscreen of a mobile device. The graphical user interface 200 includes an unlock image 201 and a plurality of visual cues 202-204 to remind the user of the gestures and options to unlock the touch screen. As shown, the unlock image 201 represents a mobile payment application. In one embodiment, the graphical user interface 200 is displayed on a locked touch screen automatically when the mobile device is located near a merchant's point-of-sale (POS) system. For example, the mobile device can detect the merchant's POS system at a close range and then establishes a connection with the POS system via Near Field Communication (or other short-range wireless technologies such as Bluetooth). Once the connection is established, the POS system transmits the total payment amount to the mobile device, which feeds the data to the payment application.

As shown in FIG. 2, the first visual cue 202 indicates the first option for the user to unlock the screen. Here, the first option represents a payment of $100 dollars with no tip. The user can drag the unlock image 201 along the track indicated by the visual cue 202 to unlock the screen. Afterwards, the mobile device displays the mobile payment application on the screen with the payment option of “$100 dollars (no tip)” selected or displayed for further confirmation by the user before finish the transaction. The second visual cue 203 indicates the second option for the user to unlock the screen. As shown, the second option represents a payment of $115 which includes a 15% tip. Similarly, the user can drag the unlock image 201 along the track indicated by the visual cue 203 to unlock the screen. Afterwards, the mobile device displays the mobile payment application on the screen with the payment option of “$115 dollars (15% tip)” selected or displayed for further confirmation by the user before finish the transaction. The third visual cue 204 indicates the third option for the user to unlock the screen. As shown, the third option represents a payment of $120 which includes a 20% tip. Similarly, the user can drag the unlock image 201 along the track indicated by the visual cue 204 to unlock the screen. Afterwards, the mobile device displays the mobile payment application on the screen with the payment option of “$120 dollars (20% tip)” selected or displayed for further confirmation by the user before finish the transaction. In all three options, the user may be required to input the correct passcode, for security protection, before the mobile device and the screen are unlocked for displaying the payment application.

FIG. 3 illustrates a plurality of unlock images displayed on a locked touch screen of a mobile device, according to some embodiments of the present invention. As shown in FIG. 3, a graphical user interface 300 is displayed on a locked touchscreen of a mobile device. The graphical user interface 300 includes a plurality of unlock images 301-303, each corresponding to a visual cue (304, 305, or 306) to remind the user of the gesture and option to unlock the touch screen. As shown, the graphical user interface 300 represents a car application. In one embodiment, the graphical user interface 300 is displayed on a locked touch screen automatically when the mobile device is located near the user's car. For example, the mobile device can detect the user's car at a close range and then establishes a connection with the car via Near Field Communication (or other short-range wireless technologies such as Bluetooth).

As shown in FIG. 3, the first unlock image 301 corresponds to the car application's function of locking or unlocking the door of the car (indicated by the first visual cue 304), the second unlock image 302 corresponds to the car application's navigation function(s) (indicated by the second visual cue 305), and the third unlock image 303 corresponds to the car application's interior control function(s) (indicated by the third visual cue 306). The user can drag one of the unlock images 301-303 along the track indicated by the corresponding visual cue (304, 305, or 306) to unlock the screen. Afterwards, the mobile device displays the car application on the screen with the corresponding function(s) selected or displayed for further confirmation or interaction by the user. Again, the user may be required to input the correct passcode, for security protection, before the mobile device and the screen are unlocked for displaying the car application.

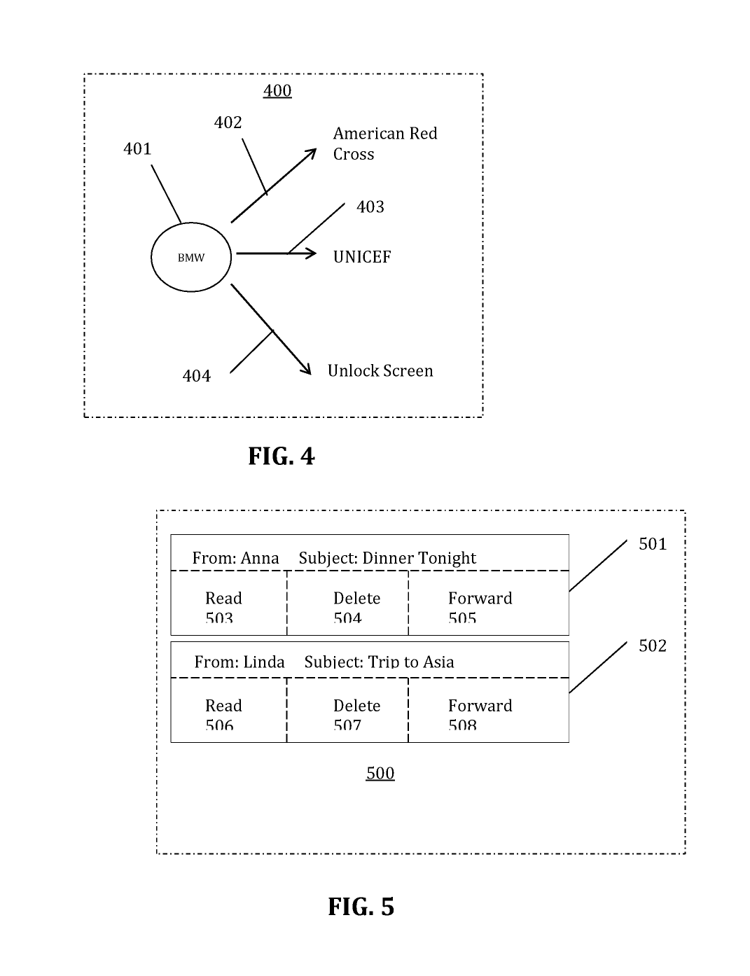

FIG. 4 illustrates an unlock image displayed on a locked touch screen of a mobile device, according to some embodiments of the present invention. As shown in FIG. 4, a graphical user interface 400 is displayed on a locked touchscreen of a mobile device. The graphical user interface 400 includes an unlock image 401 and a plurality of visual cues 402-404 to remind a user of the gestures and options to unlock the touch screen. As shown, the unlock image 401 represents a charity donation application, where a donor (e.g., a company) can choose to have its brand name or logo used as the unlock image 401. In exchange, a user can drag the donor's brand name or logo (and therefore the unlock image 401) along one of the tracks (indicated by the visual cues 402-403) to indicate to which beneficiary the user wants the donor to donate its money while unlocking the screen. Note that the option indicated by the visual cue 404 is a pure unlock option with no donation effect. Here, as shown in FIG. 4, the user can drag the unlock image 401 along the track indicated by visual cue 402 to request the donor to donate its money to the American Red Cross. Similarly, the user can drag the unlock image 401 along the track indicated by visual cue 403 to request the donor to donate its money to UNICEF. The charity donation application then communicates with a server to record the user's choice in a database. In one embodiment, the charity donation application accomplishes the above described actions in the background, even after the screen is unlocked.

The charity donation application may randomly select a donor and display that donor's brand name or logo as the unlock image 401. Alternatively, the application may select a donor based on the mobile device's current location. For example, if the application determines that the mobile device is located near a coffee shop, it may select that coffee shop's brand name or logo as the unlock image 401, assuming that coffee shop has registered as a donor.

FIG. 5 illustrates a plurality of unlock images displayed on a locked touch screen of a mobile device, according to some embodiments of the present invention. As shown, the graphical user interface 500 includes a plurality of unlock images 501-502, each representing an incoming email message. Furthermore, there are multiple options for a user to interact with each unlock image (501 or 502) so that the user can trigger a particular function of the email application while unlocking the screen. Each option is indicated by a visual cue. For example, unlock image 501 has three options indicated by visual cues 503-505, respectively. The first option is indicated by visual cue 503 and corresponds to the read function of the email application, the second option 504 is indicated by visual cue 504 and corresponds to the delete function of the email application, and the third option 505 is indicated by visual cue 505 and corresponds to the forward function of the email application. The user can press the screen area defined by a visual cue (503, 504, or 505) for a prolonged period of time to unlock the screen. Afterwards, the mobile device displays the email application on the screen with the corresponding function activated. For example, if the user pressed the screen area corresponds to the read function, after the screen is unlocked, the email application displays the corresponding incoming email on the screen for the user to read. If the user pressed the screen area corresponds to the delete function, after the screen is unlocked, the email application displays a screen showing that the corresponding incoming email has been deleted. If the user pressed the screen area corresponds to the forward function, after the screen is unlocked, the email application creates a new email with the corresponding incoming email attached for forwarding. Similarly, the unlock image 502, which represents another incoming email, has three options indicated by visual cues 506-508. In all three options, the user may be required to input the correct passcode, for security protection, before the mobile device and the screen are unlocked for displaying the email application.

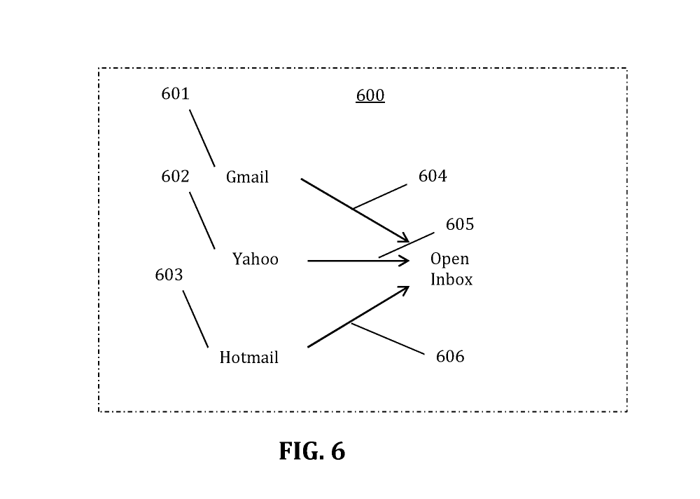

FIG. 6 illustrates a plurality of unlock images displayed on a locked touch screen of a mobile device, according to some embodiments of the present invention. As shown, the graphical user interface 600 includes a plurality of unlock images 601-603, each representing an email account (e.g., Gmail™ 601, Yahoo™ 602, and Hotmail™ 603). For each unlock image, there is an option indicated by a visual cue. For example, unlock image 601 has one option indicated by visual cue 604, which corresponds to the function of opening inbox of the Gmail™ account, unlock image 602 has one option indicated by visual cue 605, which corresponds to the function of opening inbox of the Yahoo™ account, and unlock image 603 has one option indicated by visual cue 606, which corresponds to the function of opening inbox of the Hotmail™ account. The user can swipe the screen along the visual cue (604, 605, or 606) to unlock the screen. Afterwards, the mobile device displays the corresponding email account depending on which unlock image the user selected.

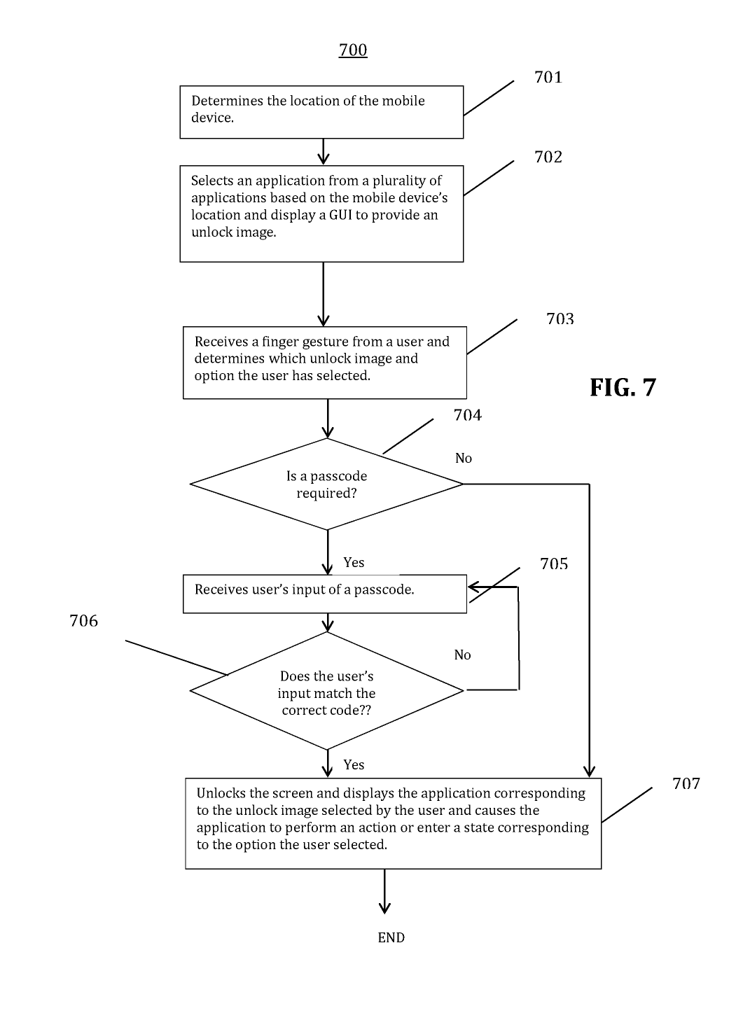

FIG. 7 is a flow diagram illustrating a process 700 of unlocking a locked touch screen of a mobile device, according to some embodiments of the present invention. The process 700 may be implemented as part of the operating system or a standalone application of a mobile device. At step 701, the process 700 determines the location of the mobile device. The location could be an absolute location (which may be determined by the mobile device's GPS function) or a relative location with reference to a signal source (e.g., close to a POS system or a car).

At step 702, the process 700 selects an application from a plurality of applications based on the mobile device's location and display a graphical user interface, such as the one illustrated in FIG. 2, FIG. 3, FIG. 4, FIG. 5, or FIG. 6. The mobile device may maintain a list of applications that have been installed on it. Also, for each application, the mobile device maintains a set of data that can be rendered into a graphical user interface, such as the one illustrated in FIG. 2, FIG. 3, FIG. 4, FIG. 5, or FIG. 6.

At step 703, the process 700 receives a finger gesture on the touch screen from a user and determines which unlock image and option the user has selected.

At step 704, the process 700 determines whether a passcode is required for unlocking the screen and the device. If a passcode is not required, the process 700 goes to step 707. If a passcode is required, the process 700 goes to step 705, where the process 700 displays a screen to request the user to input a passcode.

At step 706, the process 700 receives an input from the user and determines whether the user's input matches the correct passcode. If they do not match, the process 700 goes back to step 705. Otherwise, the process 700 goes to step 707.

At step 707, the process 700 unlocks the screen and displays the application corresponding to the unlock image selected by the user. Further, the process 700 causes the application to perform an action or enter a state corresponding to the option the user selected.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A computer-implemented method for unlocking a touch screen of a mobile electronic device, the method comprising:
determining a location of the mobile electronic device;
selecting an application from a plurality of applications installed on the mobile electronic device based on the location;
displaying a plurality of Graphic User Interface (GUI) objects to offer a plurality of options for unlocking the touch screen if the touch screen is locked, each option corresponding to a distinct action to be performed by said application; and
upon receiving a user's action of selecting one option from the plurality of options, unlocking the touch screen and performing the action corresponding to the option.

2. The computer-implemented method of claim 1, wherein each distinct action comprises making a payment of a different amount.

3. The computer-implemented method of claim 1, wherein each distinct action comprises causing a different operation to be performed on a vehicle.

4. The computer-implemented method of claim 1, wherein the plurality of GUI objects comprises one unlock image and a plurality of visual cues.

5. The computer-implemented method of claim 4, wherein the unlock image is selected based on the location of the mobile electronic device.

6. The computer-implemented method of claim 1, wherein the plurality of GUI objects comprises a plurality of unlock images and a plurality of visual cues.

7. A mobile electronic device comprising:
a touch screen;
a memory for storing instructions; and
a processor which, upon executing the instructions, performs a process comprising:
determining a location of the mobile electronic device;
selecting one or more applications from a plurality of applications installed on the mobile electronic device based on the location;
displaying a plurality of Graphic User Interface (GUI) objects to offer a plurality of options for unlocking the touch screen if the touch screen is locked, each option corresponding to a distinct action to be performed by said one or more applications; and
upon receiving a user's action of selecting one option from the plurality of options, unlocking the touch screen and performing the action corresponding to the option.

8. The mobile electronic device of claim 7, wherein each distinct action comprises making a payment of a different amount.

9. The mobile electronic device of claim 7, wherein each distinct action comprises causing a different operation to be performed on a vehicle.

10. The mobile electronic device of claim 7, wherein each distinct action comprises opening an inbox of a different email account.

11. The mobile electronic device of claim 7, wherein the plurality of GUI objects comprises one unlock image and a plurality of visual cues.

12. The mobile electronic device of claim 11, wherein the unlock image is selected based on the location of the mobile electronic device.

13. The mobile electronic device of claim 7, wherein the plurality of GUI objects comprises a plurality of unlock images and a plurality of visual cues.

14. A non-transient computer readable medium programmed with computer readable code that upon execution by a processor of a mobile electronic device causes the processor to:
determine a location of the mobile electronic device;
select one or more applications from a plurality of applications installed on the mobile electronic device based on the location;
display a plurality of Graphic User Interface (GUI) objects to offer a plurality of options for unlocking a touch screen of the mobile electronic device if the touch screen is locked, each option corresponding to a distinct action to be performed by said one or more applications; and
upon receiving a user's action of selecting one option from the plurality of options, unlock the touch screen and perform the action corresponding to the option.

15. The non-transient computer readable medium of claim 14, wherein each distinct action comprises making a payment of a different amount.

16. The non-transient computer readable medium of claim 14, wherein each distinct action comprises causing a different operation to be performed on a vehicle.

17. The non-transient computer readable medium of claim 14, wherein each distinct action comprises opening an inbox of a different email account.

18. The non-transient computer readable medium of claim 14, wherein the plurality of GUI objects comprises one unlock image and a plurality of visual cues.

19. The non-transient computer readable medium of claim 18, wherein the unlock image is selected based on the location of the mobile electronic device.

20. The non-transient computer readable medium of claim 14, wherein the plurality of GUI objects comprises a plurality of unlock images and a plurality of visual cues.
